(19) United States
(12) Patent Application Publication
(10) Pub. No.: US 2022/0057216 A1
(43) Pub. Date: Feb. 24, 2022

(54) SYSTEM AND METHOD FOR VALIDATING A ROAD OBJECT

(71) Applicant: HERE Global B.V., Eindhoven (NL)

(72) Inventors: Zhenhua Zhang, Chicago, IL (US); Leon Stenneth, Chicago, IL (US)

(21) Appl. No.: 17/095,501

(22) Filed: Nov. 11, 2020

Related U.S. Application Data
(60) Provisional application No. 63/067,704, filed on Aug. 19, 2020.

(51) Int. Cl. G01C 21/30

(52) U.S. Cl. CPC G01C 21/30; G01C 21/3602

(57) ABSTRACT

The disclosure provides a method, a system, and a computer program product in accordance with at least one example embodiment for validating a road object. The method comprises receiving at least one road object observation associated with the road object, and determining a map-matched link associated with the road object based on the road object observation. The method further comprises obtaining, for the road object observation, at least one parallel link and lane information, where the lane information comprises number of lanes information, lane width data or a combination thereof, for the map-matched link or the at least one parallel link. The method further comprises determining a distance of separation between the map-matched link and the at least one parallel link based on the lane information, and validating the road object based on the determined distance of separation.

### RELATED APPLICATION

This application claims priority from U.S. Provisional Application Ser. No. 63/067,704, entitled “SYSTEM AND METHOD FOR VALIDATING A ROAD OBJECT,” filed on Aug. 19, 2020, the contents of which are hereby incorporated herein in their entirety by this reference.

### TECHNOLOGICAL FIELD

The present disclosure generally relates to a field of road and traffic sign recognition, and more particularly relates to a system, a method, and a computer program product for validating one or more road objects.

### BACKGROUND

Road and traffic sign recognition systems detect one or more road objects on one or more roads, recognize the detected one or more road objects, and further determine one or more navigation actions to be taken based on the recognized one or more road objects. The road objects may be road signs such as speed limit signs, speed breaker signs, pylons, or the likes. The road and traffic sign recognition system can continuously monitor a driver, a vehicle, and a road in order, for example, to inform the driver in time about upcoming decision points regarding navigation and potentially risky traffic situations. Often, a route traversed or to be traversed by a user encompasses several links (or road segments) that may be in close proximity of each other, for example several roads or segments thereof may be parallel to each other. One or more road signs may be posted alongside or over each of the parallel roads to guide traffic.

Generally, posted road signs which are posted on or over a road, are learned using sensor data captured by vehicles. The sensor data comprises images of a road and road surroundings and/or data thereof. Oftentimes due to a wide field-of-view of most of the image sensors, it is highly likely that road signs posted on other roads may also get captured by the onboard sensors. Further, based on data obtained from the sensors, the road and traffic sign detection systems may make navigation decisions for a vehicle. If these detection systems are not accurate, this may lead to taking inaccurate navigation decisions such has keeping speed limit more than actually required on the current road, which may even lead to incidents such as accidents.

### SUMMARY

Road object detection systems, such as the road and traffic sign recognition systems discussed above need to perform accurate road object detection to be able to make precise and accurate navigation decisions. Especially, in the context of parallel roads, sensors onboard a vehicle traveling on a current road may erroneously capture road signs posted on the parallel roads, leading to inaccurate navigation data detection and misinformed navigation decision making problem.

Accordingly, there is a need of a system that may validate whether the detected one or more road objects are associated with the current road or not. A system, a method, and a computer program product are provided in accordance with an example embodiment described herein for validating the one or more road objects.

Embodiments of the present invention provide a system for validating a road object. The system comprises a memory configured to store computer executable instructions and one or more processors configured to execute the instructions to receive at least one road object observation associated with the road object, determine a map-matched link associated with the road object based on the road object observation, and obtain, for the road object observation, at least one parallel link and lane information, wherein the lane information comprises number of lanes data for the map-matched link or the at least one parallel link. The one or more processors are further configured to determine a distance of separation between the map-matched link and the at least one parallel link based on the lane information, and validate the road object based on the determined distance of separation.

According to some example embodiments, to determine the distance of separation between the map-matched link and the at least one parallel link, the one or more processors are further configured to determine a first location associated with the map-matched link and to determine a second location associated with the at least one parallel link. The one or more processors are further configured to obtain, from a map database, a lane width data associated with the map-matched link or the at least one parallel link, and determine the distance of separation between the map-matched link and the at least one parallel link based on the first location, the second location, the lane width data associated with the map-matched link or the at least one parallel link, and the lane information.

According to some example embodiments, to determine the distance of separation between the map-matched link and the at least one parallel link, the one or more processors are further configured to calculate a first distance between the first location and the second location, calculate a sum of link widths of each of the map-matched link and the at least one parallel link, calculate a second distance by subtracting half of the sum of the link widths of each of the map-matched link and the at least one parallel link from the first distance, and determine the distance of separation between the map-matched link and the at least one parallel link based on the second distance, the lane width data associated with the map-matched link or the at least one parallel link, and the lane information.

According to an example embodiment, the first location is associated with a center-line of the map-matched link and the second location is associated with a center-line of the at least one parallel link.

According to an example embodiment, to validate the road object based on the distance of separation, the one or more processors are further configured to validate the road object as a road object associated with the map-matched link when the distance of separation is more than a predetermined distance threshold.

According to an example embodiment, to validate the road object based on the distance of separation, the one or more processors are further configured to validate the road object as a road object not associated with the map-matched link when the distance of separation is less than a predetermined distance threshold.

According to an example embodiment, the one or more processors are further configured to update a map database based on the validation of the road object.

According to an example embodiment, to obtain the at least one parallel link and the lane information, the one or more processors are further configured to access the map database.

Embodiments of the disclosure provide a method for validating a road object. The method comprising receiving at least one road object observation associated with the road object, determining a map-matched link associated with the road object based on the road object observation, obtaining, for the road object observation, at least one parallel link and lane information, wherein the lane information comprises lane width data for the map-matched link or the at least one parallel link, determining a distance of separation between the map-matched link and the at least one parallel link based on the lane information, and validating the road object based on the determined distance of separation.

Embodiments of the disclosure provide a computer programmable product for validating a road object. The method comprising receiving at least one road object observation associated with the road object, determining a map-matched link associated with the road object based on the road object observation, obtaining, for the road object observation, at least one parallel link and lane information, wherein the lane information comprises lane width data for the map-matched link or the at least one parallel link, determining a distance of separation between the map-matched link and the at least one parallel link based on the lane information, and validating the road object based on the determined distance of separation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment of a system for validating a road object, in accordance with an example embodiment;

FIG. 2 illustrates a block diagram of the system for validating the road object, in accordance with an example embodiment;

FIG. 3A illustrates an exemplary scenario of a working example of the system, for validating the road object, in accordance with an example embodiment;

FIG. 3B illustrates relation between a separation distance between two links and a distance between center lines of each of the respective link, in accordance with an example embodiment;

FIG. 4 shows a table 1 that illustrates exemplary contents of a map databases, in accordance with an example embodiment;

FIG. 5 shows a graph that illustrates relationship between accuracy of the system for validating the road object, coverage of the system, and the separation distance between two links, in accordance with an example embodiment; and

FIG. 6 illustrates a flow diagram of a method for validating the road object, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, system and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause a system to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### DEFINITIONS

The term “road object” may be used to refer to road and traffic signs, pylons, or the like.

The term “link” may be used to refer to any connecting pathway including but not limited to a lane, a road, an aisle, an alley or the like.

The term “autonomous guided vehicle” may be used to refer to any vehicle having autonomous driving capabilities at least in some conditions. An autonomous guided vehicle, as used throughout this disclosure, may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### END OF DEFINITIONS

A method, a system, and a computer program product may be provided for validating a road object, wherein by validating the road object it may be determined whether the road object is associated with a current road (i.e. a map-matched link) or with at least one road in proximity of the current map-matched link. The at least one road in the proximity with the current map-matched link may correspond to a road parallel to the current map-matched link. The system may initially receive road object observations associated with the road object, and determine the current map-matched link and the at least one proximate link based on the road object observations. In order to validate whether the road object is associated with the current map-matched link or the at least one proximate link, the system may further determine lane information, where the lane information comprises number of lanes data for the current map-matched link or the at least one proximate link. The system further determines a distance of separation between the current map-matched link and the at least one proximate link based on the lane information, and finally validates the road object either as a road object associated with the current map-matched link or as a road object not associated with the current map matched link, based on the determined distance of separation.

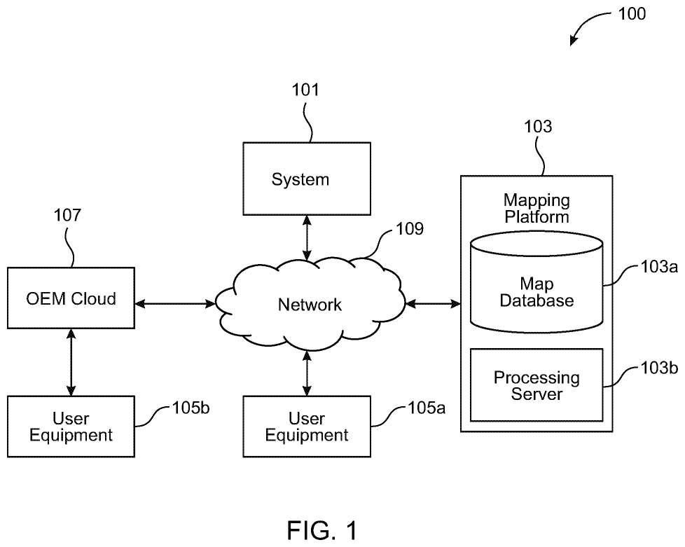

FIG. 1 illustrates a schematic diagram of a network environment 100 of a system 101 for validating a road object, in accordance with an example embodiment. The system 101 may be communicatively coupled to a mapping platform 103, a user equipment 105a and an OEM (Original Equipment Manufacturer) cloud 107 connected to a user equipment 105b, via a network 109. The components described in the network environment 100 may be further broken down into more than one component and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud based service or a cloud based platform. As such, the system 101 may be configured to operate outside the user equipment 105a and/or 105b. However, in some example embodiments, the system 101 may be embodied within one or both of user equipment 105a and 105b, for example as part of an in-vehicle navigation system. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle to validate the road object. Further, in one embodiment, the system 101 may be a standalone unit configured to validate the road object for the autonomous vehicle. Alternatively, the system 101 may be coupled with an external device such as the autonomous vehicle.

The mapping platform 103 may comprise a map database 103a for storing map data and a processing server 103b. The map database 103a may store node data, road segment data, link data, point of interest (POI) data, link identification information, heading value records or the like. The map database 103a may also store cartographic data, routing data, and/or maneuvering data. Also, the map database 103a further includes speed limit data of each lane, cartographic data, routing data, and/or maneuvering data. Additionally, the map database 103a may be updated dynamically to cumulate real time traffic conditions. The real time traffic conditions may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. The real time traffic conditions update the autonomous vehicle on slow moving traffic, lane blockages, under construction road, freeway, right of way, and the like. In one embodiment, the map database 103a may further store historical traffic data that includes travel times, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 103a may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the user equipment 105a and/or 105b. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 105a and/or 105b to provide navigation and/or map-related functions. For example, the map database 103a may be used with the user equipment 105a and/or 105b to provide an end user with navigation features. In such a case, the map database 103a may be downloaded or stored locally (cached) on the user equipment 105.

The processing server 103b may comprise processing module and communication module. For example, the processing module may comprise one or more processors configured to process requests received from the user equipment 105a, 105b. The processing module may fetch map data from the map database 103a and transmit the same to the user equipment 105 via OEM cloud 109 in a format suitable for use by the one or both of the user equipment 105a and/or 105b. In one or more example embodiments, the mapping platform 103 may periodically communicate with the user equipment 105a, 105b via the processing server 103b to update a local cache of the map data stored on the user equipment 105a, 105b. Accordingly, in some example embodiments, the map data may also be stored on the user equipment 105a, 105b and may be updated based on periodic communication with the mapping platform 103.

In some example embodiments, the user equipment 105a, 105b may be any user accessible device such as a mobile phone, a smartphone, a portable computer, and the like that is portable in itself or as a part of another portable/mobile object such as a vehicle. The user equipment 105a, 105b may comprise a processor, a memory and a communication interface. The processor, the memory and the communication interface may be communicatively coupled to each other. In some example embodiments, the user equipment 105a, 105b may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 105a, 105b may comprise a processing module such as a central processing unit (CPU), storage module such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 105a, 105b. Additional, different, or fewer components may be provided. For example, the user equipment 105a, 105b may be configured to execute and run mobile applications such as a messaging application, a browser application, a navigation application, and the like. At least one user equipment such as user equipment 105b may be directly coupled to the system 101 via the network 109. For example, the user equipment 105b may be a dedicated vehicle (or a part thereof) for gathering data for development of the map data in the database 103a. In some example embodiments, at least one user equipment such as the user equipment 105b may be coupled to the system 101 via the OEM cloud 107 and the network 109. For example, the user equipment 105b may be a consumer vehicle (or a part thereof) and may be a beneficiary of the services provided by the system 101. In some example embodiments, one or more of the user equipment 105a and 105b may serve the dual purpose of a data gatherer and a beneficiary device. The user equipment 105a or 105b may be configured to capture sensor data associated with a road which the user equipment 105a, 105b may be traversing. The sensor data may for example be image data of road objects, road signs, or the surroundings (for example buildings). The sensor data may refer to sensor data collected from a sensor unit in the user equipment 105a and/or user equipment 105b. In accordance with an embodiment, the sensor data may refer to the data captured by the vehicle using sensors.

The network 109 may be wired, wireless, or any combination of wired and wireless communication networks, such as cellular, Wi-Fi, internet, local area networks, or the like. In one embodiment, the network 109 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 109 is coupled directly or indirectly to the user equipment 105b via OEM cloud 107. In an example embodiment, the system may be integrated in the user equipment 105b. In an example, the mapping platform 103 may be integrated into a single platform to provide a suite of mapping and navigation related applications for OEM devices, such as the user devices and system 101. The system 101 may be configured to interface with the mapping platform 103 over the network 109. Thus, the mapping platform 103 may enable provision of cloud-based services for the system 101, such as, storing the lane marking observations in the OEM cloud 107 in batches or in real-time.

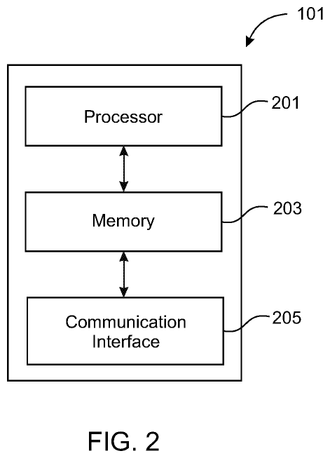

FIG. 2 illustrates a block diagram of the system 101 for validating the road object, in accordance with an example embodiment. The system 101 may include a processing module such as at least one processor 201 (hereinafter, also referred to as “processor 201”), storage module such as at least one memory 203 (hereinafter, also referred to as “memory 203”), and a communication module such as at least one communication interface 205 (hereinafter, also referred to as “communication interface 205”). The processor 201 may retrieve computer program code instructions that may be stored in the memory 203 for execution of the computer program code instructions.

The processor 201 may be embodied in a number of different ways. For example, the processor 201 may be embodied as one or more of various hardware processing modules such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the user equipment 105a, 105b or any other component with which the system 101 may communicate. The communication interface 205 may be any module such as a device or circuitry embodied in either hardware or a combination of hardware and software that is configured to receive and/or transmit data to/from a communications device in communication with the user equipment 105a, 105b. In this regard, the communication interface 205 may include, for example, an antenna (or multiple antennae) and supporting hardware and/or software for enabling communications with a wireless communication network. Additionally or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

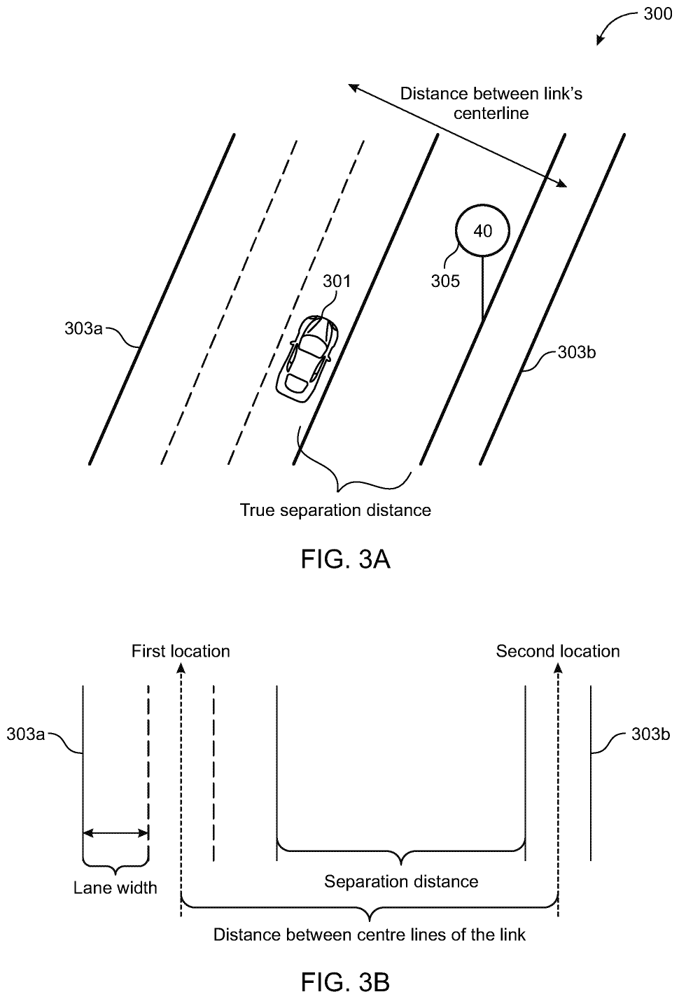

FIG. 3A illustrates an exemplary scenario 300 of a working example of the system 101, for validating the road object, in accordance with an example embodiment. FIG. 3B illustrates relation between a separation distance between two links and a distance between center lines of each of the respective link, in accordance with an example embodiment. A vehicle 301 (such as the user equipment 105a or 105b illustrated in FIG. 1) may be travelling on a main link 303a. There may be another link 303b proximate to the main link 303a. The proximate link 303b may be a link that is parallel to the main link 303a, and may the proximate link 303b may be referred to as the parallel link 303b hereinafter. Therefore, the main link 303a and the parallel link 303b may be referred to as parallel links. Further, there may be a road object 305, for example a road sign posted on the parallel link 303b that indicates speed limit 40 KMPH.

The vehicle 301 travelling on the main link 303a may capture the road object 305 falling within a field of view of onboard sensors of the vehicle 301 by recording a road object observation associated with the road object 305, using the onboard sensors of the vehicle 301, and thus the road object 305 now becomes a captured road object 305 and may be interchangeable referred to as the captured road object 305 hereinafter. The vehicle 301 may process the captured road object 305 and report it as being posted on a link on which the vehicle 301 may be traversing (in this case the main link 303a). However, since the road object 305 is associated with the parallel link 303b, the vehicle 301 may report erroneous map data regarding the road object observation for the captured road object 305. This problem is referred to as a parallel road problem. When such erroneous road object observation is learnt and is used to build/update a map database (such as the map database 103a of mapping platform 103) the map database cannot be regarded as reliable and users of such map database may be provided with improper navigation assistance. Alternately, if the erroneous observation is utilized locally by the vehicle 301 for performing navigation functions, the vehicle 301 may not be able to correctly comprehend the road object observations which can lead to undesired situations such as accidents.

Currently to validate the road object 305 a distance between centerlines of the links 303a and 303b may be determined. When the distance is more than a predetermined threshold, it may be determined that the detected road object 305 is not associated with the main link 303a. Thus, the validation of the road object 305 is based only on distance between the centerlines of the two parallel links, 303a and 303b. However, as can be observed in FIG. 3B, an actual separation distance between the two links 303a and 303b is much lesser than the distance between the centerlines of the links 303a and 303b. Therefore, validating whether the road object 305 is associated with the link 303a or not based only on the distance between the centerlines of the links 303a and 303b may give incorrect results. This is because the link 303a comprises a plurality of lanes, and without considering lane information for the link 303a, or for that matter, for the link 303b, the determination of actual separation distance between the links 303a and 303b will not be proper. This problem is overcome in the technical solution provided in various embodiments of the present invention, by considering lane information associated with link 303a or link 303b or a combination thereof. In some embodiments, this lane information comprises a number of lanes information, a lane width information or a combination thereof for one or both the links 303a and 303b.

In an example embodiment, it is possible that the vehicle 301 may be traversing on a lane of the link 303a, and the lane is very close to the link 303b. As can be observed in the FIG. 3A, the true distance between the vehicle 301 and the road object 305 is lesser than the distance between centerlines of the links 303a and 303b. As the true separation distance is much lesser than the distance between the centerlines of the link, it may be determined that the detected road object 305 is associated with the link 303a, which is erroneous, and may lead to undesired situations.

To address this issue, the proposed system 101 may provide measures for validating whether the road object 305 is associated with the main link 303a or not. For example, when the road object observation is reported at the mapping platform 103 for learning purposes, the mapping platform 103 may trigger and invoke the system 101 to determine a map-matched link associated with the road object 305. In this case, the map-matched link is the main link 303a along which the vehicle 301 is currently traversing. Based on the road object observation the system 101 further obtains at least one parallel link, in this case link 303b, and lane information, where the lane information comprises number of lanes data for the map-matched link 303a and/or the at least one parallel link 303b. The system 101 may access the map databases 103a to obtain the map-matched link 303a, the at least one parallel link 303b, and the lane information. The system 101 determines a distance of separation between the map-matched link 303a and the at least one parallel link 303b based on the lane information, and then validates the road object 305 based on the determined distance of separation.

The system 101 may determine the distance of separation between the map-matched link 303a and the at least one parallel link 303b by first determining a first location associated with the map-matched link 303a and a second location associated with the at least one parallel link 303b, where the first location and the second location are map-matched locations. As can be observed from FIG. 3B, the first location is associated with the center-line of the map-matched link, that is the main link 303a in this case and the second location is associated with the center-line of the at least one parallel link, that is the parallel link 303b in this case. In an example embodiment, the system 101 may also obtain a lane width data associated with the map-matched link 303a and/or the at least one parallel link 303b from the map database 103a. The system 101 may further calculate a sum of link width of each of the map-matched link 303a and the at least one parallel link 303b. Further, the system 101 calculates a first distance between the first location and the second location; and a second distance by subtracting half of the sum of the link width of each of the map-matched link 303a and the at least one parallel link 303b from the first distance. The system 101 then determines the distance of separation between the links 303a and 303b based on the second distance, the lane width data associated with the map-matched link and/or the at least one parallel link, and the lane information, where the lane information comprises number of lanes data for the map-matched link 303a and/or the at least one parallel link 303b.

Further, the system 101 may use the determined distance of separation to validate the road object 305. To that end, the system 101 compares the determined distance of separation with a predetermined distance threshold. The system 101 validates the road object 305 as a road object associated with the map-matched link when the distance of separation is more than the predetermined distance threshold. The predetermined threshold may be a configurable value that may be configured based on different locations or different environmental conditions. Further, the predetermined threshold may be an ideal computed distance between two proximate links based on analysis of historic data or errors in wrong road object detection. Further, the system 101 validates the road object 305 as a road object not associated with the map-matched link 303a when the distance of separation is less than the predetermined distance threshold. Further, based on the validation of the road object 305, the system 101 may update the map database 103a.

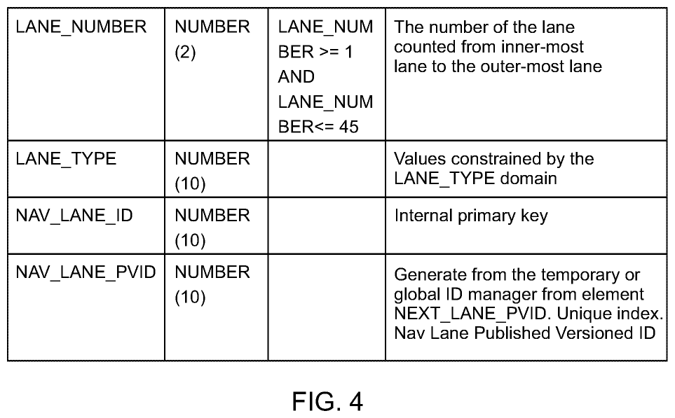

FIG. 4 shows a table 1 that illustrates exemplary contents of the map database 103a, in accordance with an example embodiment. As can be observed in the FIG. 4, table 1 comprises information associated with lanes of at least one link in a particular region. The information in the table 1 may change based on changes in environmental conditions and changes in locations. The table 1 comprises lane information associated with the at least one link. The lane information provided by the table 1 comprises LANE_NUMBER and LANE_TYPE. The LANE_NUMBER provides a number of lanes of the at least one link. The number of lanes may be determined by counting from inner-most lane of a link to the outer-most lane of the link. LANE_TYPE provides domain and type of the lane information.

Further, the table 1 comprises identifications (IDs) such as NAV_LANE_ID and NAV_LANE_PVID that provide unique identifications for the lane information provided by the table 1. The information provided by the table 1 may be combined with other information associated with the at least one link, such as any of the links 303a or 303b, stored in the map database 103a. In an example embodiment, there may be a plurality of databases in the map database 103a, where each database of the plurality of databases may store different information associated with the at least one link, where the information comprises may be such as shape of the at least one link, curvatures of the at least one link, or the like. The system 101 may use combination of the information stored in the plurality of databases of the map database 103a to provide accurate navigation suggestions to a user. The NAV_LANE_ID and NAV_LANE_PVID may be used to accurately identify information provided by the table 1.

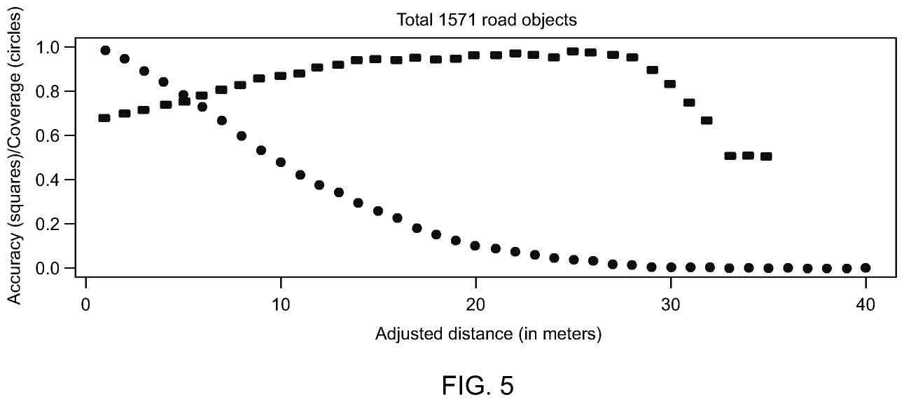

FIG. 5 shows a graph that illustrates relationship between accuracy of the system 101 for validating the road object 305, coverage of the system 101, and the separation distance between two parallel links, in accordance with an example embodiment. The graph is constructed based on total 1571 road objects which are associated with the parallel roads. In the graph, X axis represents adjusted distance in meters. The adjusted distance corresponds to the distance of separation between two proximate links. The graph provides analysis of effect of adjusting the separation distance on the accuracy of the system and the number of samples required for the accuracy. Further, the Y axis represents the accuracy or coverage of the system 101 for validating the road object 305. The coverage of the system 101 may provide an indication of how man road objects and their associated road object observations can be evaluated using the system 101. The accuracy is represented with black rectangles and adjusted distance is represented with black circles. Some of the objectives of the proposed system 101 are to determine a proper separation distance such that the accuracy of the system 101 is as high as 95% with optimized number of samples and cover maximum number of road objects. To achieve these, the distance of separation is adjusted. It is evident from the graph, that as the adjusted distance increases (within 0-25 meters) the accuracy steadily increases, and the coverage also steadily increases. An optimal adjusted distance, where the system 101 has accuracy of approximately 95% (or 0.95) with the optimal coverage may be determined around 15 meters based on the graph. However, the optimal distance may vary based on different locations or different environmental conditions. For example, if there are 100 truly parallel road objects, such as parallel road signs, in an area, then under a distance threshold of 20 meters, we may find 90 parallel signs and only 80 are correct. Then, the coverage is 80/100=80% and accuracy is 80/90=88.9%. Further, under a distance threshold of 200 meters, we may find 1000 parallel signs and only 100 are correct. Then, the coverage is 100/100=100% and accuracy is 100/1000=10%. Thus, both coverage and accuracy is from 0 to 1 and there is a tradeoff here between both. However, a correct value can be selected by adjusting the coverage and accuracy based on the tradeoff and validating the road object accordingly.

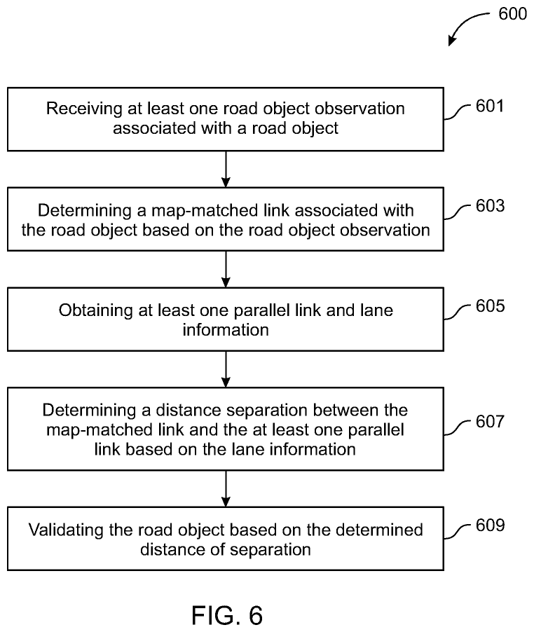

FIG. 6 illustrates a flow diagram of a method 600 for validating the road object, in accordance with an example embodiment. The method 600 begins at step 601, where at least one road object observation associated with the road object may be received. The road object may be a traffic sign, a pylon, or the likes. The road object observations may be received from one or more vehicles, where the one or more vehicles may comprise sensors that may capture the road object observation and report the road object observations to the system 101.

On reception of the road object observation, at step 603, a map-matched link (such as the link 303a) associated with the road object may be determined based on the road object observation. The map-matched link is a link on which the one or more vehicles, such as the vehicle 301, are traversing.

At step 605, based on the received road object observations at least one proximate link and lane information may be obtained. For example, the at least one parallel link 303b is a proximate link. Thus, the at least one proximate link is in proximity of the map-matched link and may comprise a link parallel to the map-matched link. The lane information may comprise lane width data for the map-matched link and/or the at least one proximate link. The lane information may further comprise number of lanes data for the map-matched link and/or the at least one proximate link, such as depicted in table 1 provided in FIG. 4. The map-matched link, the at least one proximate link, and the lane information may be obtained from the map database 103a.

Further, the method proceeds to step 607, where a distance of separation between the map-matched link and the at least one proximate link may be determined based on the lane information. In order to determine the separation distance, a first location associated with a center-line of the map-matched link and a second location associated with a center-line of the at least one proximate link may be determined, and a first distance between the first location and the second location may be determined. The first location and the second location are map-matched locations. Further, a second distance may be calculated by subtracting half the sum of the link widths of each of the map-matched link and the at least one proximate link from the first distance. Thus, the separation distance between the map-matched link and the at least one proximate link is based on the first distance, the second distance, the lane width data associated with the map-matched link or the at least one proximate link, and the number of lanes data associated with the map-matched link or the at least one proximate link.

At step 609, the road object, such as the road object 305, may be validated based on the separation distance. To validate the road object, the separation distance may be compared with a predetermined threshold. The road object may be validated as a road object associated with the map-matched link when the distance of separation is more than the predetermined distance threshold. On the other hand, the road object may be validated as a road object not associated with the map-matched link when the distance of separation is less than the predetermined distance threshold.

The method 600 may be implemented using corresponding circuitry. For example, the method 600 may be implemented by the system 101 comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, a system for performing the method 600 of FIG. 6 above may comprise a processor (e.g. the processor 201) configured to perform some or each of the operations of the method 600 of FIG. 6 described previously. The processor may, for example, be configured to perform the operations (601-609) by performing hardware implemented logical functions, executing stored instructions, or executing algorithms for performing each of the operations. Alternatively, the system may comprise modules for performing each of the operations described above. In this regard, according to an example embodiment, examples of modules for performing operations (601-609) may comprise, for example, the processor 201 which may be implemented in the system 101 and/or a device or circuit for executing instructions or executing an algorithm for processing information as described above.

In this way, example embodiments of the invention results in providing validation of detected one or more road objects on a map-matched link and updating the map database 103a accordingly. The updated map database 103a enables the system 101 to accurately determine whether the detected one or more road objects are associated with a map-matched link or at least one proximate link, where the at least one proximate link is in proximity of the map-matched link (for example, a link parallel to the map-matched link). Thus, an end user may be provided with accurate and reliable navigation assistance. Therefore, embodiments of the present disclosure may provide improvements in the map database and/or the navigation assistance by validating the one or more road objects as one or more road objects associated with the map-matched link or the at least one proximate link.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for validating a road object, the system comprising:
a memory configured to store computer-executable instructions; and
one or more processors configured to execute the stored computer-executable instructions to:
receive at least one road object observation associated with the road object;
determine a map-matched link associated with the road object based on the road object observation;
obtain, for the road object observation, at least one parallel link and lane information, wherein the lane information comprises number of lanes data for the map-matched link or the at least one parallel link;
determine a distance of separation between the map-matched link and the at least one parallel link based on the lane information; and
validate the road object based on the determined distance of separation.

2. The system of claim 1, wherein to determine the distance of separation between the map-matched link and the at least one parallel link, the one or more processors are further configured to:
determine a first location associated with the map-matched link;
determine a second location associated with the at least one parallel link;
obtain, from a map database, a lane width data associated with the map-matched link or the at least one parallel link; and
determine the distance of separation between the map-matched link and the at least one parallel link based on the first location, the second location, the lane width data associated with each of the map-matched link or the at least one parallel link, and the lane information.

3. The system of claim 2, wherein to determine the distance of separation between the map-matched link and the at least one parallel link, the one or more processors are further configured to:
calculate a first distance between the first location and the second location;
calculate a sum of link width of each of the map-matched link and the at least one parallel link;
calculate a second distance by subtracting half of the sum of the link width of each of the map-matched link and the at least one parallel link from the first distance; and
determine the distance of separation between the map-matched link and the at least one parallel link based on the second distance, the lane width data associated with the map-matched link or the at least one parallel link, and the lane information.

4. The system of claim 2, wherein the first location is associated with a center-line of the map-matched link and the second location is associated with a center-line of the at least one parallel link.

5. The system of claim 1, wherein to validate the road object based on the distance of separation, the one or more processors are further configured to:
validate the road object as a road object associated with the map-matched link when the distance of separation is more than a predetermined distance threshold.

6. The system of claim 1, wherein to validate the road object based on the distance of separation, the one or more processors are further configured to:
validate the road object as a road object not associated with the map-matched link when the distance of separation is less than a predetermined distance threshold.

7. The system of claim 1, wherein the one or more processors are further configured to update a map database based on the validation of the road object.

8. The system of claim 1, wherein to obtain the at least one parallel link and the lane information, the one or more processors are further configured to access a map database.

9. A method for validating a road object, the method comprising:
receiving at least one road object observation associated with the road object;
determining a map-matched link associated with the road object based on the road object observation;
obtaining, for the road object observation, at least one parallel link and lane information, wherein the lane information comprises lane width data for the map-matched link or the at least one parallel link;
determining a distance of separation between the map-matched link and the at least one parallel link based on the lane information; and
validating the road object based on the determined distance of separation.

10. The method of claim 9, wherein the lane information further comprises number of lanes data associated with the map-matched link, the at least one parallel link, or a combination thereof.

11. The method of claim 10, wherein determining the distance of separation between the map-matched link and the at least one parallel link further comprises:
determining a first location associated with the map-matched link;
determining a second location associated with the at least one parallel link; and
determining the distance of separation between the map-matched link and the at least one parallel link based on the first location, the second location, the lane width data associated with the map-matched link or the at least one parallel link, and the number of lanes data associated with the map-matched link or the at least one parallel link.

12. The method of claim 11, wherein determining the distance of separation between the map-matched link and the at least one parallel link further comprises:
calculating a first distance between the first location and the second location;
calculating a sum of link widths of each of the map-matched link and the at least one parallel link;
calculating a second distance by subtracting half of the sum of the link widths of each of the map-matched link and the at least one parallel link from the first distance; and
determining the distance of separation between the map-matched link and the at least one parallel link based on the second distance, the lane width data associated with the map-matched link or the at least one parallel link, and the number of lanes data associated with the map-matched link or the at least one parallel link.

13. The method of claim 11, wherein the first location is associated with a center-line of the map-matched link and the second location is associated with a center-line of the at least one parallel link.

14. The method of claim 9, wherein validating the road object further comprises:
validating the road object as a road object associated with the map-matched link when the distance of separation is more than a predetermined distance threshold.

15. The method of claim 9, wherein validating the road object further comprises:
validating the road object as a road object not associated with the map-matched link when the distance of separation is less than a predetermined distance threshold.

16. The method of claim 9, further comprising updating a map database based on the validation of the road object.

17. A computer programmable product comprising a non-transitory computer readable medium having stored thereon computer executable instructions which when executed by one or more processors, cause the one or more processors to validate a road object, the instructions comprising:
receiving at least one road object observation associated with the road object;
determining a map-matched link associated with the road object based on the road object observation;
obtaining, for the road object observation, at least one proximate link and lane information, wherein the lane information comprises lane width data, number of lanes data, or a combination thereof for the map-matched link or the at least one proximate link;
determining a distance of separation between the map-matched link and the at least one proximate link based on the lane information; and
validating the road object based on the determined distance of separation.

18. The computer program product of claim 17, wherein for determining the distance of separation between the map-matched link and the at least one proximate link, the instructions further comprise:
determining a first location associated with the map-matched link;
determining a second location associated with the at least one proximate link; and
determining the distance of separation between the map-matched link and the at least one proximate link based on the first location, the second location, the lane width data associated with the map-matched link or the at least one proximate link and the number of lanes data associated with the map-matched link or the at least one proximate link.

19. The computer program product of claim 18, wherein for determining the distance of separation between the map-matched link and the at least one proximate link, the operations further comprise:
calculating a first distance between the first location and the second location;
calculating a sum of link widths of each of the map-matched link and the at least one proximate link;
calculating a second distance by subtracting half of the sum of the link widths of each of the map-matched link and the at least one proximate link from the first distance; and
determining the distance of separation between the map-matched link and the at least one proximate link based on the second distance, the lane width data associated with the map-matched link or the at least one parallel link, and the number of lanes data associated with the map-matched link or the at least one proximate link.

20. The computer program product of claim 17, wherein for validating the road object the operations further comprise:
validating the road object as a road object associated with the map-matched link when the distance of separation is less than a predetermined distance threshold, or
validating the road object as a road object not associated with the map-matched link when the distance of separation is more than a predetermined distance threshold.
